(19) United States
(12) Patent Application Publication
(10) Pub. No.: US 2026/0298891 A1
(43) Pub. Date: Oct. 1, 2026

(54) Application of reagents for detecting blood metabolites in the preparation of products for the diagnosis of colorectal cancer

(71) Applicant: Cancer Hospital, Chinese Academy of Medical Sciences, Beijing (CN)

(72) Inventors: Wei Cui, Beijing (CN); Xiaoying Lou, Beijing (CN); Feng Chen, Beijing (CN); Jia Li, Beijing (CN)

(21) Appl. No.: 19/574,605

(22) Filed: Mar. 23, 2026

(30) Foreign Application Priority Data
Mar. 25, 2025 (CN) 2025103533171

(51) Int. Cl. G01N 30/72; G01N 30/02; G01N 30/86; G01N 30/88

(52) U.S. Cl. CPC G01N 30/7233; G01N 30/8679; G01N 30/88; G01N 2030/027; G01N 2030/8822; G01N 2030/884

(57) ABSTRACT

An application of a reagent for detecting blood metabolites in the preparation of a product for the diagnosis of colorectal cancer is provided, which belongs to the technical field of disease diagnostic reagents. The blood metabolites include one or more of BN03, BP01, TLCA, or LCA. These blood metabolites can distinguish between healthy individuals and patients with colorectal lesions, serving as biomarkers for colorectal cancer diagnosis.

### TECHNICAL FIELD

The present invention belongs to the technical field of disease diagnostic reagents, and specifically relates to an application of a reagent for detecting blood metabolites in the preparation of a product for the diagnosis of colorectal cancer.

### BACKGROUND

Colorectal cancer (CRC) is a common malignant tumor and one of the leading causes of cancer-related mortality. Currently, colonoscopy is the primary method for CRC diagnosis and screening; however, its invasive nature and patient compliance limitations restrict its widespread application. The fecal occult blood test (FOBT) is a simple and rapid CRC screening method, and CEA is also a commonly used CRC serum marker, but their sensitivity and specificity still need improvement.

With the development of metabolomics analysis technology, metabolic markers identified by Liquid Chromatography-Mass Spectrometry (LC-MS/MS) are expected to become new CRC biomarkers, such as lipid metabolites like fatty acids and bile acids.

Because blood metabolites have advantages over fecal metabolites in terms of sample collection and less direct dietary influence, the clinical application of blood metabolites in colorectal cancer has attracted more attention.

### SUMMARY

The present invention identifies that blood metabolites BN03 (9,12,13-TriHOME), BP01 (myristoyl-L-carnitine), TLCA (taurocholic acid), and LCA (lithocholic acid) are related to the occurrence and development of colorectal cancer and can serve as biomarkers for the diagnosis of colorectal cancer.

To achieve the above objectives, the present invention can adopt the following technical solutions:

Firstly, the present invention provides an application of a reagent for detecting blood metabolites in the preparation of a product for the diagnosis of colorectal cancer. The blood metabolites include one or more of BN03 (9,12,13-TriHOME), BP01 (myristoyl-L-carnitine), TLCA (taurocholic acid), and LCA (lithocholic acid).

Preferably, in the above application, the reagent for detecting blood metabolites is based on an LC-MS/MS detection method.

Preferably, in the above application, the blood metabolites include BN03 (9,12,13-TriHOME) and LCA (lithocholic acid).

Preferably, in the above application, the colorectal cancer refers to colorectal dysplasia, stage I colorectal cancer, or stage II colorectal cancer.

Preferably, in the above application, the product is a detection kit or a detection reagent.

Secondly, the present invention also provides a system for the diagnosis of colorectal cancer, including:
an analysis unit for obtaining results of biomarkers of a subject, wherein the biomarkers include one or more of BN03 (9,12,13-TriHOME), BP01 (myristoyl-L-carnitine), TLCA (taurocholic acid), and LCA (lithocholic acid);
an evaluation unit for assigning corresponding evaluation scores to the obtained biomarker results to derive a total score;
an output unit for generating the subject's colorectal cancer diagnosis result based on the total score obtained from the evaluation unit;

Preferably, in the above system, the biomarkers are BN03 (9,12,13-TriHOME), BP01 (myristoyl-L-carnitine), TLCA (taurocholic acid), and LCA (lithocholic acid); the total score y=(−8.24)+2.0456×BN03+0.0730×BP01+(−0.0078)×LCA+(−0.2206)×TLCA.

Preferably, the biomarkers in the above system also include CEA (carcinoembryonic antigen).

Preferably, the colorectal cancer in the above system refers to colorectal dysplasia, stage I colorectal cancer, or stage II colorectal cancer.

The beneficial effects of the present invention include:

(1) When using BN03 (9,12,13-TriHOME) as a biomarker for the diagnosis of colorectal cancer, the area under the curve (AUC) for distinguishing colorectal lesions from apparently healthy individuals was 0.930 (95% CI: 0.899-0.962); for distinguishing early-stage colorectal cancer, high-risk adenomas from low-risk adenomas and apparently healthy individuals, the AUC was 0.882 (95% CI: 0.836-0.927). At a cutoff value of 3.865 ng/ml, its sensitivity and specificity were 85.62% and 91.95%, respectively, which were higher than the AUC of carcinoembryonic antigen (CEA) (0.778, 95% CI: 0.718-0.838).

(2) When BN03 (9,12,13-TriHOME) was used in combination with CEA as a marker for colorectal cancer diagnosis, the sensitivity and specificity reached 89.31% and 85.87%, respectively.

(3) When using LCA (lithocholic acid) as a marker for colorectal cancer diagnosis, a sensitivity of 50.33% and specificity of 96.55% were observed at LCA level exceeding 88.09 ng/mL.

(4) When BN03 (9,12,13-TriHOME) was used in combination with LCA as a marker for colorectal cancer diagnosis, the sensitivity and specificity were improved to 86.93% and 89.66%, respectively, which was superior to using LCA alone as a marker.

### BRIEF DESCRIPTION OF DRAWINGS

FIG. 1 shows the concentrations of BN03, BP01, TLCA, and LCA in CRC patients;

FIG. 2 shows the detection performance of different marker combinations;

FIG. 3 shows the metabolic model for the patients with colorectal abnormalities versus healthy individuals.

### DETAILED DESCRIPTION OF EMBODIMENTS

The examples provided are intended to better illustrate the present invention, but the scope of the present invention is not limited to these examples. Therefore, non-essential improvements and adjustments to the implementation made by those skilled in the art based on the above inventive content remain within the protection scope of the present invention.

The terminology used herein is intended to describe specific embodiments only and is not intended to limit the scope of the disclosure. Unless the context clearly indicates otherwise, expressions in the singular forms include expressions in the plural forms. As used herein, it should be understood that terms such as “include,” “have,” and “comprise” are intended to indicate the presence of features, numbers, operations, components, parts, elements, materials, or combinations thereof. The disclosure of terms in the specification of the present invention is not intended to exclude the possibility that one or more additional features, numbers, operations, components, parts, elements, materials, or combinations thereof may exist or be added. As used herein, “/” may be interpreted as “and” or “or” depending on the context.

The present invention provides an application of a reagent for detecting blood metabolites in the preparation of a product for the diagnosis of colorectal cancer, wherein the blood metabolites include one or more of BN03 (9,12,13-TriHOME), BP01 (myristoyl-L-carnitine), TLCA (taurolithocholic acid), or LCA (lithocholic acid).

It should be noted that the present invention discovered that compared to healthy individuals, the concentrations of BN03, BP01, TLCA, and LCA in CRC (colorectal cancer) patients were significantly increased, indicating that BN03, BP01, TLCA, and LCA could serve as biomarkers for the diagnosis of colorectal cancer; Among them, BN03 demonstrated the best performance, with an area under the curve (AUC) of 0.930 (95% CI: 0.899-0.962) for distinguishing colorectal lesions from apparently healthy individuals, and an area under the curve of 0.882 (95% CI: 0.836-0.927) for distinguishing early-stage colorectal cancer (including Stage I and II colorectal cancer), high-risk adenomas (which can be considered precancerous lesions) from low-risk adenomas (which have a certain risk of malignant transformation) and apparently healthy individuals. At a cutoff value of 3.865 ng/ml, its sensitivity and specificity were 85.62% and 91.95%, respectively. Additionally, the present invention established a method for detecting serum lipid metabolites using LC-MS/MS and confirmed that the detection performance met CLSI requirements.

In some specific examples, the reagents for detecting blood metabolites in the above applications are based on the LC-MS/MS detection method.

It should be noted that the reagents for detecting blood metabolites in the present invention can be any reagent known in the art capable of detecting the above-mentioned blood metabolites in blood samples, such as reagents based on LC-MS/MS detection methods, like mobile phases or buffers.

It should also be noted that LC-MS/MS is a common method for metabolite analysis and can measure multiple metabolites simultaneously. The sensitivity of blood metabolites identified using LC-MS/MS for CRC diagnosis can reach 93.6%, with a specificity of 80.2%.

In some specific examples, in the above applications, the blood metabolites include BN03 (9,12,13-TriHOME) and LCA (lithocholic acid).

It should be noted that the present invention discovered that combining BN03 with LCA as biomarkers for CRC diagnosis, the sensitivity and specificity were increased to 86.93% and 89.66%, which is superior to using LCA alone as a marker.

In some specific examples, the colorectal cancer in the above applications refers to colorectal dysplasia, stage I colorectal cancer, or stage II colorectal cancer.

In some specific examples, the product in the above applications is a detection kit or detection reagent.

It should be noted that the product for the diagnosis of colorectal cancer in the present invention can be a detection kit or a detection reagent, generally being a detection kit, which is more convenient for transportation and storage.

The present invention also provides a system for the diagnosis of colorectal cancer, including: an analysis unit for obtaining results of biomarkers of a subject, wherein the biomarkers include one or more of BN03 (9,12,13-TriHOME), BP01 (myristoyl-L-carnitine), TLCA (taurocholic acid), and LCA (lithocholic acid);
an evaluation unit for assigning corresponding evaluation scores to the obtained biomarker results to derive a total score;
an output unit for generating the subject's colorectal cancer diagnosis result based on the total score obtained from the evaluation unit;

In some specific examples, the biomarkers in the above system are BN03 (9,12,13-TriHOME), BP01 (myristoyl-L-carnitine), TLCA (Taurocholate), and LCA (lithocholic acid); The total score y=(−8.24)+2.0456×BN03+0.0730×BP01+(−0.0078)×LCA+(−0.2206)×TLCA.

In some specific examples, the biomarkers in the above system also include CEA.

It should be noted that when the CEA cut-off value was 5 ng/ml, the sensitivity and specificity were 33.33% and 98.85%, respectively; when BN03 was combined with the CEA, the sensitivity and specificity reached 89.31% and 85.87%, respectively.

It should also be noted that the present invention established a method for detecting serum lipid metabolites based on LC-MS/MS and confirmed that the detection performance met CLSI requirements. It is found that the combined detection of BN03 and CEA biomarker can improve detection sensitivity.

In specific examples, colorectal cancer in the above system refers to colorectal dysplasia, stage I colorectal cancer, or stage II colorectal cancer.

To better understand the present invention, the following specific examples further illustrate its content, but the scope of the present invention is not limited to the following examples.

In the following examples, High Performance Liquid Chromatography (HPLC) grade acetonitrile (ACN), methanol (MeOH), isopropanol (IPA), ammonium formate, and formic acid (FA) were purchased from ThermoFisher Scientific. Deionized water (>18.2 MΩ·cm) was obtained from Watsons; Lithocholylglycine (GLCA), glycocholic acid (GCA), deoxycholic acid (DCA), cholic acid (CA), tauroursodeoxycholic acid (TUDCA), ursodeoxycholic acid (UDCA), taurocholic acid (TCA), taurodeoxycholic acid (TDCA), glycochenodeoxycholic acid (GCDCA), taurochenodeoxycholic acid (TCDCA), glycodeoxycholic acid monohydrate (GDCA), lithocholic acid (LCA), chenodeoxycholic acid (CDCA), glycoursodeoxycholic acid (GUDCA), (±) 15-HETE (BN01), 12,13-DiHOME (BN02), 9,12,13-TriHOME (BN03), myristoyl-L-carnitine (BP01), trans-2-octenoyl-L-carnitine (BP02), trans-2-hexadecenoyl-L-carnitine (BP03), and (±)-hexanoylcarnitine chloride (BP04) were purchased from Shanghai YuanYe Biotechnology, Alfa Aesar, China National Institutes for Food and Drug Control, zzstandard, BePuro, ISOREAG, MCE, Sigma, and TRC, respectively; purchased from ISOREAG and BePure.

In the following examples, the 22 blood metabolites are GLCA, GCA, DCA, CA, TUDCA, UDCA, TCA, TDCA, GCDCA, TCDCA, GDCA, LCA, CDCA, GUDCA, TLCA, BN01, BN02, BN03, BP01, BP02, BP03, and BP04; specific information is shown in Table 1 below.

TABLE 1
Information on 22 Blood Metabolites

| Metabolite | English Name |
|---|---|
| GLCA | Lithocholylglycine |
| GCA | glycocholic acid |
| DCA | deoxycholic acid |
| CA | cholic acid |
| TUDCA | tauroursodeoxycholic acid |
| UDCA | ursodeoxycholic acid |
| TCA | taurocholic acid |
| TDCA | taurodeoxycholic acid |
| GCDCA | glycochenodeoxycholic acid |
| TCDCA | taurochenodeoxycholic acid |
| GDCA | glycodeoxycholic acid monohydrate |
| LCA | lithocholic acid |
| CDCA | chenodeoxycholic acid |
| GUDCA | glycoursodeoxycholic acid |
| TLCA | Taurolithocholic acid |
| BN01 | (±) 15-HETE |
| BN02 | 12,13-DiHOME |
| BN03 | 9,12,13-TriHOME |
| BP01 | myristoyl-L-carnitine |
| BP02 | trans-2-octenoyl-L-carnitine |
| BP03 | trans-2-hexadecenoy-1-L-carnitine |
| BP04 | (±) -hexanoylcamitine chloride |

In the following examples, serum metabolites were detected according to the following steps:

(1) Sample Preparation: Serum metabolite extraction: Add 10 μL of internal standard mixture (a mixture of internal standards for the above metabolites, which are isotope-labeled counterparts of these compounds) to 80 μL of serum. Add 150 μL of acetonitrile and isopropanol mixture (acetonitrile:isopropanol 4:1 v/v, ThermoFisher) and 50 μL of ammonium formate (0.5 g/mL), vortex and centrifuge at 17,949×g for 10 m. Dilute 60 μL of the supernatant with 150 μL HPLC-grade water before use.

(2) Liquid Chromatography-Mass Spectrometry Tandem Analysis Procedure: LC-MS/MS analysis was performed using an AB SCIIEX Triple Quad™ 4500 system; the injection volume for each mode was 10 μL; mass spectrometer parameters for each metabolite were optimized by infusing corresponding standards using electrospray ionization (ESI) in positive and negative ion mode (see Table 2 below). Serum metabolites were eluted at a flow rate of 0.075 mL/min from a Shim-pack Velox column (C18, 2.7 μm, 50×2.1 mm); gradient elution with mobile phase A (water containing 0.1% formic acid) and mobile phase B (acetonitrile containing 0.1% formic acid): 0-0.2 min: 25% B, 0.2-0.8 min: 25%-40% B, 0.8-2 min: 40%-45% B, 2-2.5 min: 45%-60% B, 2.5-3.6 min: 60%-70% B, 3.6-5 min: 70%-98% B, 5-5.1 min: 98%-25% B. Metabolite peaks were integrated using Sciex Analyst 1.6.3 and MultiQuant 3.0.2 software.

TABLE 2
Mass spectrometer parameters for each metabolite

| | Retention | | | | | |
|---|---|---|---|---|---|---|
| Analyte | time (min) | Q1 | Q3 | DP | CE | ESI mode |
| BN01 | 3.42 | 319.3 | 219.3 | −90 | −18 | Negative |
| BN02 | 2.68 | 313.2 | 183.1 | −90 | −30 | Negative |
| BN03 | 1.48 | 329.1 | 229.1 | −95 | −29 | Negative |
| CA | 1.86 | 407 | 407 | −90 | −30 | Negative |
| CA-d4 | 1.86 | 411.3 | 411.3 | −90 | −30 | Negative |
| DCA | 2.89 | 391.001 | 391.001 | −90 | −35 | Negative |
| DCA_d4 | 2.89 | 395.101 | 395.101 | −90 | −30 | Negative |
| CDCA | 2.78 | 391.002 | 391.002 | −90 | −30 | Negative |
| CDCA_d4 | 2.78 | 395.102 | 395.102 | −90 | −30 | Negative |
| UDCA | 1.96 | 391.003 | 391.003 | −90 | −30 | Negative |
| UDCA_d4 | 1.96 | 395.103 | 395.103 | −90 | −30 | Negative |
| LCA | 3.59 | 375 | 375 | −90 | −30 | Negative |
| LCA_d4 | 3.59 | 379.1 | 379.1 | −90 | −30 | Negative |
| GCA | 1.5 | 464.1 | 464.1 | −90 | −35 | Negative |
| GCA_d4 | 1.5 | 468 | 468 | −90 | −30 | Negative |
| GDCA | 2.07 | 448.101 | 448.101 | −90 | −35 | Negative |
| GDCA_d4 | 2.07 | 452.201 | 452.201 | −90 | −30 | Negative |
| GCDCA | 1.95 | 448.102 | 448.102 | −90 | −35 | Negative |
| GCDCA_d4 | 1.95 | 452.202 | 452.202 | −90 | −30 | Negative |
| GUDCA | 1.51 | 448.103 | 448.103 | −90 | −35 | Negative |
| GUDCA_d4 | 1.51 | 452.203 | 452.203 | −90 | −30 | Negative |
| GLCA | 2.98 | 432.1 | 432.1 | −90 | −40 | Negative |
| GLCA_d4 | 2.98 | 436.2 | 436.2 | −90 | −30 | Negative |
| TCA | 1.29 | 513.9 | 513.9 | −90 | −40 | Negative |
| TCA_d4 | 1.29 | 518.1 | 518.1 | −90 | −40 | Negative |
| TDCA | 1.6 | 498.101 | 498.101 | −90 | −65 | Negative |
| TDCA_d4 | 1.6 | 502.101 | 502.101 | −90 | −40 | Negative |
| TCDCA | 1.53 | 498.102 | 498.102 | −90 | −65 | Negative |
| TCDCA_d4 | 1.53 | 502.102 | 502.102 | −90 | −40 | Negative |
| TUDCA | 1.25 | 498.103 | 498.103 | −90 | −65 | Negative |
| TUDCA_d4 | 1.25 | 502.103 | 502.103 | −90 | −40 | Negative |
| TLCA | 2.14 | 482.1 | 482.1 | −90 | −65 | Negative |
| TLCA_d4 | 2.14 | 486.2 | 486.2 | −90 | −40 | Negative |
| BP01 | 3.01 | 372.9 | 85 | 100 | 40 | Positive |
| BP02 | 0.88 | 286.2 | 125.1 | 60 | 25 | Positive |
| BP03 | 3.3 | 398.3 | 339.1 | 70 | 25 | Positive |
| BP04 | 0.45 | 260.2 | 85 | 60 | 25 | Positive |
| BP012_d3 | 0.45 | 263.2 | 85 | 60 | 25 | Positive |

In the following examples, statistical analysis was conducted as follows: Data with normal distribution are presented as mean±standard deviation, while results with non-normal distribution are shown as median±interquartile range. Normality was tested using the Shapiro-Wilk test. Pairwise comparisons among three groups with non-normal distribution were performed using the Kruskal-Wallis test, followed by post-hoc Bonferroni correction. Statistical analysis and graphing were conducted using GraphPad Prism (9.5) or R software. *, p<0.05; **, p<0.01; ***, p<0.001; n.s., no significance.

In the following examples, serum metabolite extraction involved: adding 10 μL of internal standard mixture to 80 μL serum (or blank matrix plasma), adding 150 μL acetonitrile:isopropanol (4:1 v/v, ThermoFisher), and 50 μL ammonium formate (0.5 g/mL), vortexing at 17,949×g for 10 min, diluting 60 μL supernatant with 150 μL HPLC-grade water before use.

### I. Biomarker Screening

The present invention detected blood metabolites in serum samples from 50 colorectal cancer (CRC) patients and healthy controls who visited the Cancer Hospital, Chinese Academy of Medical Sciences between March and July in 2024 according to the following method, and found that compared with healthy individuals, the concentrations of BN03, BP01, TLCA, and LCA in CRC patients were significantly increased, indicating that BN03, BP01, TLCA, and LCA have the potential to serve as markers for the diagnosis of CRC patients.

### II. Biomarker Validation

### (i) Clinical Samples

Serum samples were collected from 247 CRC patients and healthy controls (different from the 50 samples used in the above biomarker screening) who visited the Cancer Hospital, Chinese Academy of Medical Sciences between March and July in 2024. Samples were stored at −80° C. until testing, and the CEA test results for each individual were recorded. All patients with colorectal lesions were newly diagnosed and untreated, with pathological confirmation. Patients with secondary colorectal cancer or those with concurrent tumors or relevant medical histories were excluded.

Baseline characteristics of all patients and apparently healthy controls are shown in Table 3.

TABLE 3
Baseline Characteristics of All Patients
and Apparently Healthy Controls

| | CRC (N = 117) | CRA (N = 36) | NC (N = 87) |
|---|---|---|---|
| Gender | | | |
| Male | 75 | 18 | 48 |
| Female | 42 | 18 | 39 |
| Age (Mean ± SD) | 61.55 ± 11.33 | 64.08 ± 10.11 | 52.79 ± 12.59 |
| Stage | | | |
| I-II | 28 | | |
| III-IV | 32 | | |
| unknown | 57 | | |

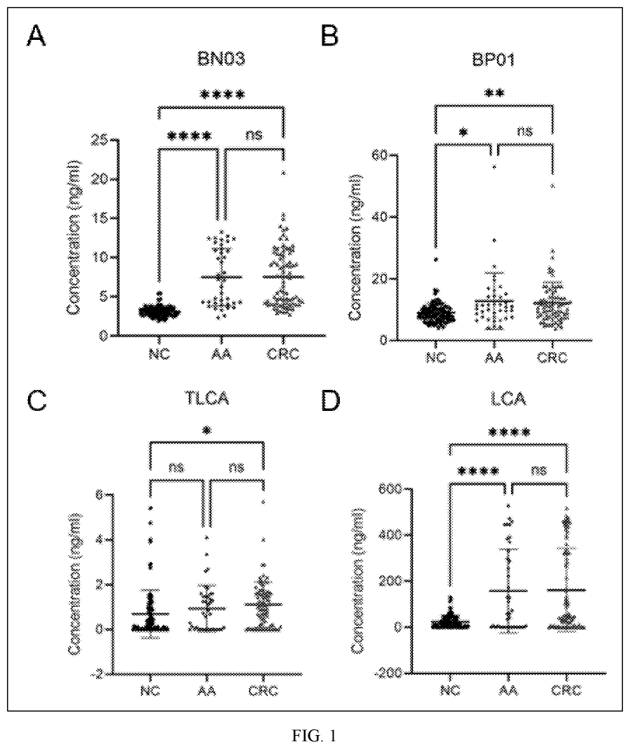

According to the serum metabolite detection method described above, the concentrations of 18 blood metabolites (BN02, BN03, BP01, BP04, CA, DCA, CDCA, GCA, GUDCA, GLCA, TCA, TDCA, TCDCA, TUDCA, and TLCA) were measured in 247 samples. The results showed that all these serum metabolites met the standards for linear range, minimum limit of quantitation, precision, and accuracy. Furthermore, compared with healthy individuals, the concentrations of BN03, BP01, TLCA, and LCA in CRC patients were significantly increased (P<0.05, refer to Table 4 and FIG. 1). This indicates that BN03, BP01, TLCA, and LCA can serve as markers for the diagnosis of CRC patients.

TABLE 4
Concentrations of BN03, BP01, TLCA, and LCA in CRC Patients

| Blood | | | |
|---|---|---|---|
| Metab- | | | |
| olites | NC | AA | CRC |
| BN03 | 2.05-5.26 | 5.77 (4.10-10.68) | 7.65 (4.29-10.72) |
| BP01 | 4.42-15.27 | 12.23 (7.79-16.07) | 11.16 (7.87-14.35) |
| TLCA | 0.00-4.61 | 0.98 (0.00-1.51) | 1.24 (0.40-1.87) |
| LCA | 0.00-121.40 | 40.76 (0.00-325.50) | 103.80 (22.06-346.40) |

### (ii) AUC Value Calculation

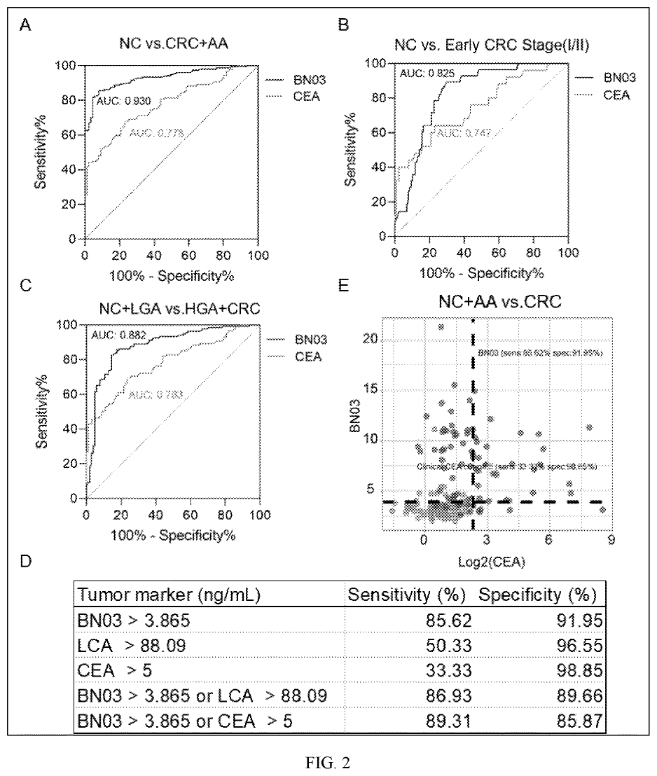

The AUC values of the above four biomarkers (BN03, BP01, TLCA, and LCA) were analyzed separately. The results showed that among these four differential metabolites, BN03 demonstrated an area under the curve (AUC) of 0.930 (95% CI: 0.899-0.962) for distinguishing colorectal abnormalities from normal controls (NC), which was higher than the AUC of carcinoembryonic antigen (CEA) (0.778, 95% CI: 0.718-0.838) (portion A of FIG. 2). Additionally, the AUC of BN03 for distinguishing early-stage CRC (Stage I/II) from NC was 0.825 (95% CI: 0.759-0.869) (portion B of FIG. 2). Furthermore, adenomas can be classified into high-grade and low-grade adenomas. Patients with high-grade adenomas are more likely to progress to CRC and require more clinical intervention. When distinguishing colorectal abnormalities from NC, the AUC of BN03 was 0.882 (95% CI: 0.759-0.869), which was superior to that of CEA (AUC: 0.783, 95% CI: 0.723-0.842) (portion C of FIG. 2).

(iii) Combined Analysis of LC-MS/MS-Based Metabolites and CEA

To further explore the clinical value of BN03 in combination with other biomarkers, the ability of BN03, LCA, and CEA to distinguish colorectal abnormalities from healthy individuals at their respective cut-off values was analyzed. The results showed:

As shown in portion D of FIG. 2, when BN03 exceeded the cut-off value of 3.865 ng/mL, the sensitivity was 85.62% and the specificity was 91.95%; when LCA exceeded 88.09 ng/mL, the sensitivity was 50.33% and the specificity was 96.55%; CEA at the cut-off value of 5 ng/mL had a sensitivity of 33.33% and a specificity of 98.85%; the combined analysis of BN03 and LCA improved sensitivity and specificity to 86.93% and 89.66%, respectively, which was superior to using LCA alone; when BN03 was combined with CEA, the sensitivity was 89.31% and the specificity was 85.87%.

Additionally, as shown in portion E of FIG. 2, among 86 CEA-negative CRC patients, 72 exhibited elevated BN03 levels; among 22 BN03-negative CRC patients, 8 showed elevated CEA levels. Therefore, the combined analysis of BN03 and CEA improved the sensitivity and specificity of CRC detection.

### (iv) Construction of a Metabolic Signature

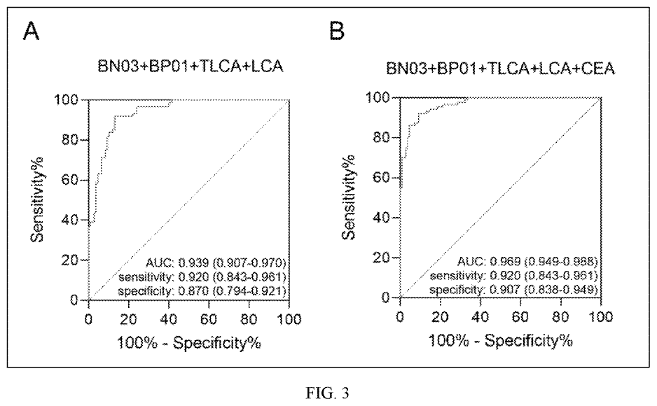

A metabolic model for distinguishing patients with colorectal abnormalities from healthy individuals was constructed using LASSO regression analysis (FIG. 3). The formula of the metabolic model is as follows:

y=(−8.24)+2.0456×BN03+0.0730×BP01+(−0.0078)×LCA+(−0.2206)×TLCA;

where, in the formula, BN03, BP01, LCA, and TLCA represent the corresponding detected concentrations; the coefficients for each metabolite were calculated using the R software package “glmnet”.

The AUC of this model for distinguishing colorectal abnormalities from NC was 0.939 (95% CI: 0.907-0.970), with a sensitivity of 92.00% and a specificity of 87.00%. Furthermore, the AUC of the combined analysis of the four-metabolite model and CEA was 0.969 (95% CI: 0.949-0.988), with a sensitivity of 92.00% and a specificity of 90.70%. These results indicate that combined analysis of CRC-related blood metabolites quantified by LC-MS/MS technology can improve the accuracy of the diagnosis of colorectal abnormalities.

Finally, it should be noted that the above examples are provided to illustrate the technical solutions of the present invention only and are not intended to be limiting. Although the present invention has been described in detail with reference to preferred examples, those skilled in the art should understand that modifications or equivalent substitutions to the technical solutions of the present invention can be made without departing from the spirit and scope of the technical solutions of the present invention, and all such modifications and substitutions should be covered within the scope of the claims of the present invention.

What is claimed is:

1. Application of a reagent for detecting blood metabolites in the preparation of a product for distinguishing colorectal cancer from healthy subjects, wherein the blood metabolites are 9,12,13-TriHOME (BN03), myristoyl-L-carnitine (BP01), taurocholic acid (TLCA), and lithocholic acid (LCA); the colorectal cancer refers to colorectal dysplasia, stage I colorectal cancer, or stage II colorectal cancer.

2. The application according to claim 1, characterized in that the reagent for detecting blood metabolites is a reagent based on a liquid chromatography-tandem mass spectrometry (LC-MS/MS) detection method.

3. The application according to claim 1, characterized in that the product is a detection kit or a detection reagent.

4. A system for distinguishing colorectal cancer from healthy subjects, characterized by comprising:
an analysis unit for obtaining results of biomarkers of a subject, wherein the biomarkers are BN03, BP01, TLCA, and LCA;
an evaluation unit for assigning corresponding evaluation scores based on the obtained biomarker results to derive a total score; the total score y=(−8.24)+2.0456×BN03+0.0730×BP01+(−0.0078)×LCA+(−0.2206)×TLCA;
an output unit for generating the subject's colorectal cancer diagnosis result based on the total score obtained from the evaluation unit;
the colorectal cancer refers to colorectal dysplasia, stage I colorectal cancer, or stage II colorectal cancer.

5. The system according to claim 4, characterized in that the biomarkers further include carcinoembryonic antigen (CEA).
